(19) United States
(12) Patent Application Publication
(10) Pub. No.: US 2014/0077597 A1
(43) Pub. Date: Mar. 20, 2014

(54) POWER ELECTRONICS DEVICE, COOPERATIVE CONTROL METHOD, COOPERATIVE CONTROL SYSTEM AND COMPUTER READABLE MEDIUM

(71) Applicant: KABUSHIKI KAISHA TOSHIBA, Tokyo (JP)

(72) Inventors: Yasuyuki NISHIBAYASHI, Kawasaki-Shi (JP); Keiichiro TERAMOTO, Tokyo (JP); Kotaro ISE, Kawasaki-Shi (JP)

(73) Assignee: KABUSHIKI KAISHA TOSHIBA, Tokyo (JP)

(21) Appl. No.: 14/022,590

(22) Filed: Sep. 10, 2013

(30) Foreign Application Priority Data
Sep. 18, 2012 (JP) 2012-204379

(51) Int. Cl. H02J 4/00

(52) U.S. Cl. CPC H02J 4/00
USPC 307/31

(57) ABSTRACT

A power electronics device includes: first and second connection units, a power conversion unit and a control unit. The first and second connection units are connected to a first power line and a second power line, respectively. The power conversion unit converts power input from one of the first and second connection units and output the converted power to the other of the first and second connection units. The control unit identifies, based on power connection information indicative of a connection relationship between a plurality of power electronics devices through the plurality of power lines, picks up a group of power electronics devices on the same power line, decides the master power electronics device from the group, and orders the master power electronics device to control other power electronics devices among the group with respect to at least one of power output to or power input from the power line.

### CROSS REFERENCE TO RELATED APPLICATIONS

This application is based upon and claims the benefit of priority from the prior Japanese Patent Application No. 2012-204379 filed on Sep. 18, 2012, the entire contents of which are incorporated herein by reference.

### FIELD

Embodiments described herein relates to a power electronics device, a cooperative control method, a cooperative control system and a computer readable medium.

### BACKGROUND

It is supposed a system in which inverter units (i.e. power electronics devices) are provided with a communication function and autonomous cooperative control is applied between the power electronics devices so as to provide the flexibility of installation locations for the power electronics devices and enable fully-automatic capacity increase at the time of expansion of a power electronics device and maintenance of the power electronics device.

At this time, for example, in a case where multiple power electronics devices are activated in parallel to increase an output of power, it is necessary to consider a phase synchronization function of output power. An object of the phase synchronization of output power is to prevent an occurrence of cross current (e.g. reactive current caused by a difference of electromotive force, synchronization cross current caused by a phase difference of electromotive force and harmonic cross current caused by a waveform difference of electromotive force) in an output on the alternating-current side. In this case, however, it is essential to determine the subject of control, namely a master device (or simply “master”) in the multiple power electronics devices. A power electronics device controlled by the master corresponds to a slave device (or simply “slave”).

In the related art, there is disclosed a method of operating multiple power electronics devices in parallel by optical communication and implementing a phase synchronization of output power without using a current-limiting reactor. Also, there is disclosed a method of dynamically coping with allocation of output/input power amount between the multiple power electronics devices.

However, when multiple power electronics devices are installed and operated, a problem is that manual management becomes complicated as the scale increases. For example, regarding determination of a master/slave relationship between multiple power electronics devices, it is presumably applied to a small number of units in the related art. As in a massive phase synchronization function of output power, in order to activate multiple power electronics devices as master candidates in parallel, it is necessary to determine a master/slave relationship in multiple layers. Although a configuration between units varies depending on the use (e.g. allocation of output/input power amount or phase synchronization of output power) of power electronics devices, a supposition is fixed in the related art.

Also, in using wireless communication for communication connection between power electronics devices, a case may occur where, because of wireless physical propagation characteristics, a communication connection relationship and a power connection relationship do not have a one-to-one correspondence with each other. In this case, a mere application of the related art causes a problem of inability to correctly perform operations by the plurality of power electronics devices.

As described above, the related art does not solve a problem of manual management becoming complicated as the scale increases when multiple power electronics devices are installed and operated. Also, although a configuration between units varies every use of power electronics devices, the supposition in the related art provides a framework of fixed setting.

### BRIEF DESCRIPTION OF THE DRAWINGS

FIG. 1 is an overall system structural view according to an embodiment;

FIG. 2 is a battery storage system structural view according to an embodiment;

FIG. 3 is an EV system structural view according to an embodiment;

FIG. 4 is a system structural view of a plurality of power electronics devices according to an embodiment;

FIG. 5 is a view illustrating a connection format between power electronics devices according to an embodiment;

FIG. 6 is a structural view of a power electronics device according to an embodiment;

FIG. 7 is a view illustrating hierarchical configuration information, communication connection information and power connection information according to an embodiment;

FIG. 8 is a decision flowchart of a power electronics device according to an embodiment;

FIG. 9 is a view illustrating an example configuration file of a power electronics device according to an embodiment;

FIG. 10 is a view illustrating a connection format and operation between power electronics devices according to an embodiment;

FIG. 11 is a view illustrating an operation sequence of a power electronics device according to an embodiment;

FIG. 12 is a view illustrating a power connection relationship and communication connection relationship between power electronics devices according to an embodiment;

FIG. 13 is a decision flowchart as to whether to perform master determination processing according to an embodiment;

FIG. 14 is a decision flowchart as to whether to perform master determination processing according to an embodiment;

FIG. 15 is an operation flowchart of master determination processing according to an embodiment;

FIG. 16 is a view illustrating a communication message exchanged between power electronics devices according to an embodiment;

FIG. 17 is a view illustrating priority criteria for master determination according to an embodiment; and

FIG. 18 is a view exemplifying a configuration automatic configuration table according to an embodiment.

### DETAILED DESCRIPTION

According to some embodiments, there is provided a power electronics device including: a first connection unit, a second connection unit, a power conversion unit and a control unit.

The first connection unit is connected to a first power line that is one of a plurality of power lines.

The second connection unit is connected to a second power line that is another one of the plurality of power lines.

The power conversion unit converts power input from one of the first connection unit and the second connection unit, and output the converted power to the other of the first connection unit and the second connection unit.

The control unit identifies, based on power connection information indicative of a connection relationship between a plurality of power electronics devices through the plurality of power lines and picks up a group of power electronics devices on the same power line.

The control unit decides the master power electronics device from the group, and orders the master power electronics device to control other power electronics devices among the group with respect to at least one of power output to or power input from the power line.

Hereinafter, embodiments will now be explained with reference to the drawings.

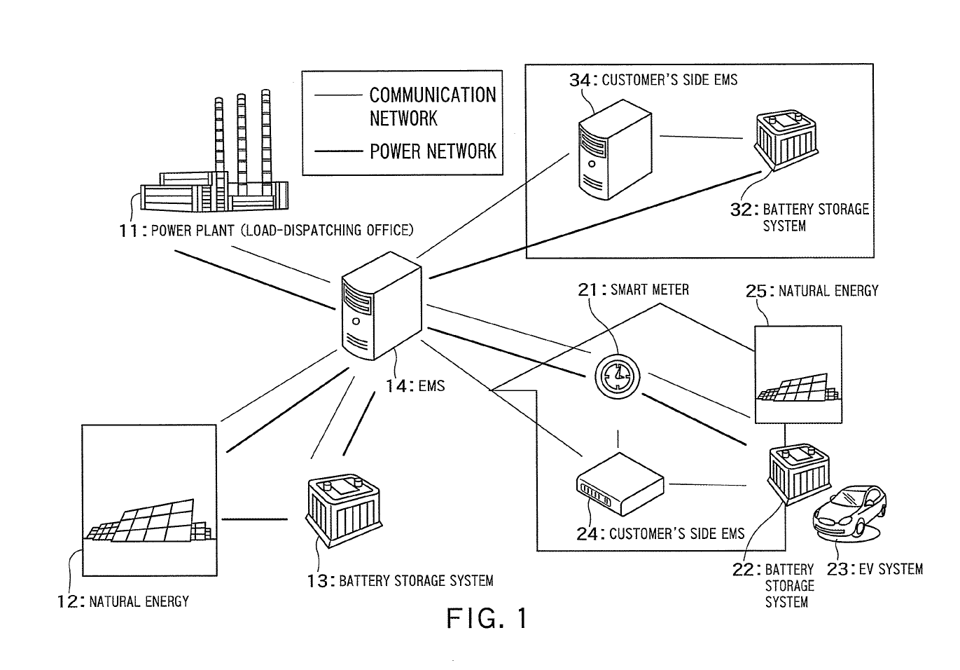

FIG. 1 presents a system configuration according to an embodiment. On a power system network, there are provided a power plant (or load-dispatching office) 11, a natural energy system 12, a battery storage system 13 and an EMS (Energy Management System) 14. Also, on the side of customers such as a home or building, there are provided a smart meter 21, battery storage systems 22 and 32, an EV (Electric Vehicle) system 23 and customer's side EMS's 24 and 34. The EMS 24 on the home customer side is referred to as “HEMS (Home Energy Management System)” and the EMS 34 on the building customer side is referred to as “BEMS (Building Energy Management System),” which manage the energy amount on premises. Also, a natural energy system 25 and the battery storage systems 22 and 32 are connected to inverters (i.e. power electronics devices) that convert the direct current and the alternating current.

The power plant (or load-dispatching office) 11 generates a large amount of power by fuel sources such as thermal power and nuclear power, and supplies it to the side of customers such as homes, buildings and factories through transmission and distribution networks. In the present specification, the transmission and distribution networks from the power plant 11 to the customers are collectively referred to as “power system network.”

The natural energy system 12 generates power from energy existing in the natural world such as wind power and sunlight, and, in the same way as the power plant, supplies the power from the power system network to the customers through transmission and distribution networks. By installing the natural energy system 12 in the power system network, it is possible to reduce the burden in the power plant and efficiently perform an operation.

Here, the battery storage system 13 has a role to store surplus power generated in the power plant 11 and the natural energy system 12.

Also, the EMS 14 has a role to perform control of stabilizing the whole power system including supply power of the power plant 11 and the natural energy system 12 and load power consumed on the customer side, using both a power network and a communication network.

The smart meter 21 measures the electric energy consumed on the customer side premise and periodically reports it to a management server of an electric power provider. Generally, although the management server is referred to as “MDMS (Metering Data Management System),” its illustration is omitted in FIG. 1. The EMS 14 can calculate the total amount of load power on the customer side in cooperation with the MDMS.

The battery storage system 22 installed in a customer's premise stores power supplied from the system network of the electric power provider or the natural energy system 25 on the premise. The EV system 23 stores power in an in-vehicle battery through a battery charger.

The HEMS performs adjustment control of the power consumption amount in the home and the BEMS performs adjustment control of the power consumption amount in the building or factory. As described above, the embodiments are applicable to not only the home but also the building or factory in the same way. In this case, as a substitute for the home HEMS, the BEMS performs adjustment control of the power consumption in the building and an FEMS (Factory Management System) performs adjustment control of the power consumption on the premise.

As the use on the system side of the electric power provider in the battery storage system 13, a battery storage system is utilized to realize a function called “ancillary service” (i.e. short-period control) that stabilizes a system by performing output adjustment on the second time scale according to instantaneous load changes in order to maintain the electrical quality such as system frequency or voltage.

Also, as the use of the battery storage system 22 on the home or building customer side, it may be utilized to realize a function called “peak shift” (i.e. day operation) that stores nighttime power of a lower unit price to implement interchange in a time zone in which the diurnal power use is peak.

Here, the power electronics device converts power between direct-current power input/output in/from the battery storage or the natural energy system and alternating-current power of the power system network.

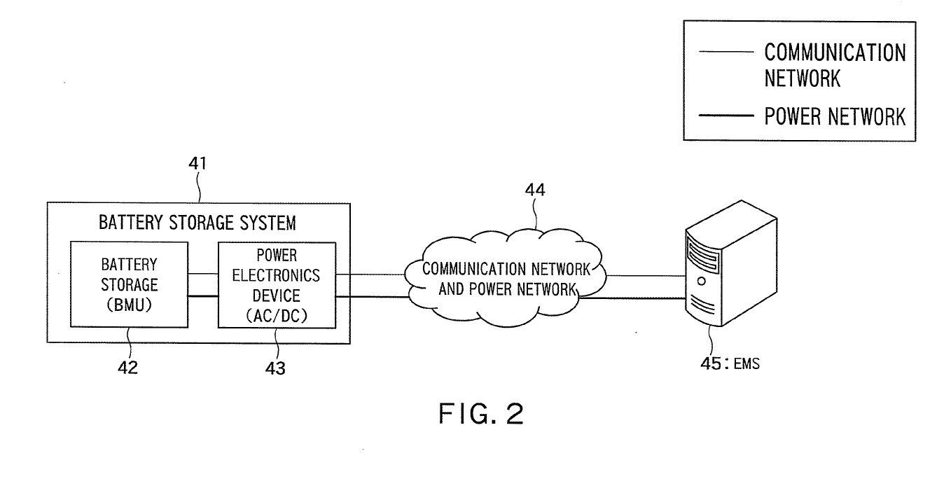

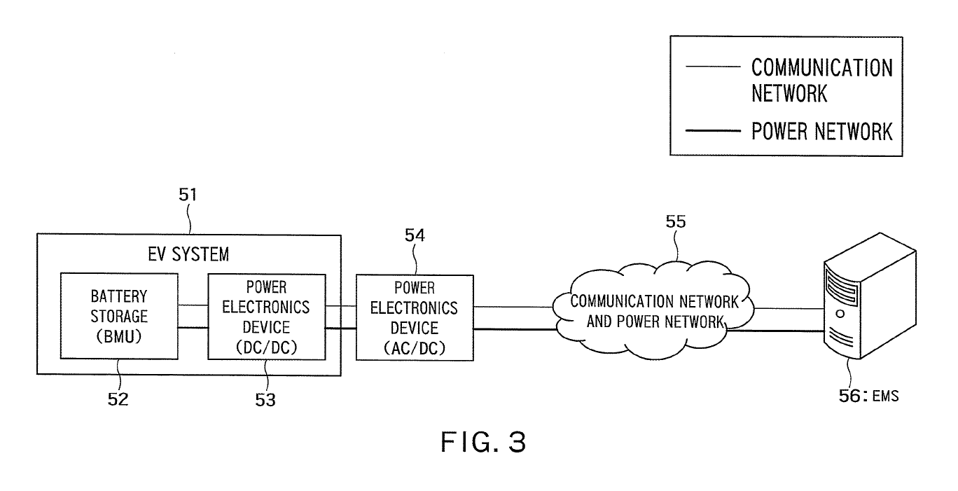

FIG. 2 and FIG. 3 illustrate basic system configurations of a power electronics device according to the embodiment. These are details of part of the system configuration in FIG. 1. FIG. 2 presents a detailed configuration of the battery storage system and FIG. 3 presents a derailed configuration of the EV system. It is basically assumed that a battery storage system 41 is used in a fixed position and an EV system 51 is used in a vehicle. Alternatively, for example, even if a battery storage 42 in the battery storage system 41 is replaced with a natural energy system such as wind power and solar power generation, the same system is applicable.

The battery storage system 41 in FIG. 2 is formed with a battery storage (BMU: Battery Management Unit) 42 and a power electronics device 43. The battery storage system 41 is connected to each EMS 45 via a communication network and power network 44. The power electronics device 43 is also called “inverter,” “converter” or “PCS (Power Conditioning System)” and therefore has a role to convert an input/output of power and adjust the voltage amount. The battery storage (BMU) 42 includes multiple battery cells and an internal processor to manage the state inside a battery pack, and implements charge/discharge control of power based on a request from the power electronics device 43. The battery storage (BMU) 42 reports information such as the rated voltage, the maximum current value at the time of discharge and charge, the SOC (State Of Charge) and the SOH (State Of Health) to the power electronics device 43.

In the example of FIG. 2, the power electronics device 43 exchanges direct-current power with the battery storage 42 and alternating-current power with the power network. Although the power electronics device 43 performs direct-current/alternating-current conversion and voltage change suppression, it is considered that these functions themselves are implemented on a processor connected to the outside of the device.

Also, regarding procedures for the charge/discharge control and the information report between the battery storage (BMU) 42 and the power electronics device 43, in addition to a method of realizing them using a CAN (Controller Area Network), there is a possible method of realizing them using a wire communication medium such as Ethernet or a wireless communication medium such as a wireless LAN (Local Area Network), and, furthermore, an electrical signal line that is uniquely defined by a vendor who sells products. However, the embodiment is not limited to any communication unit.

The power electronics device 43 in the battery storage system 41 in FIG. 2 has a communication function and communicates with each EMS 45 installed in the power system network or the customer's premise. Generally, since a battery storage has a feature of self-discharge, by acquiring information such as SOC and SOH from the battery storage system 41, the EMS 45 can appropriately monitor the state that changes over time and instruct charge/discharge control.

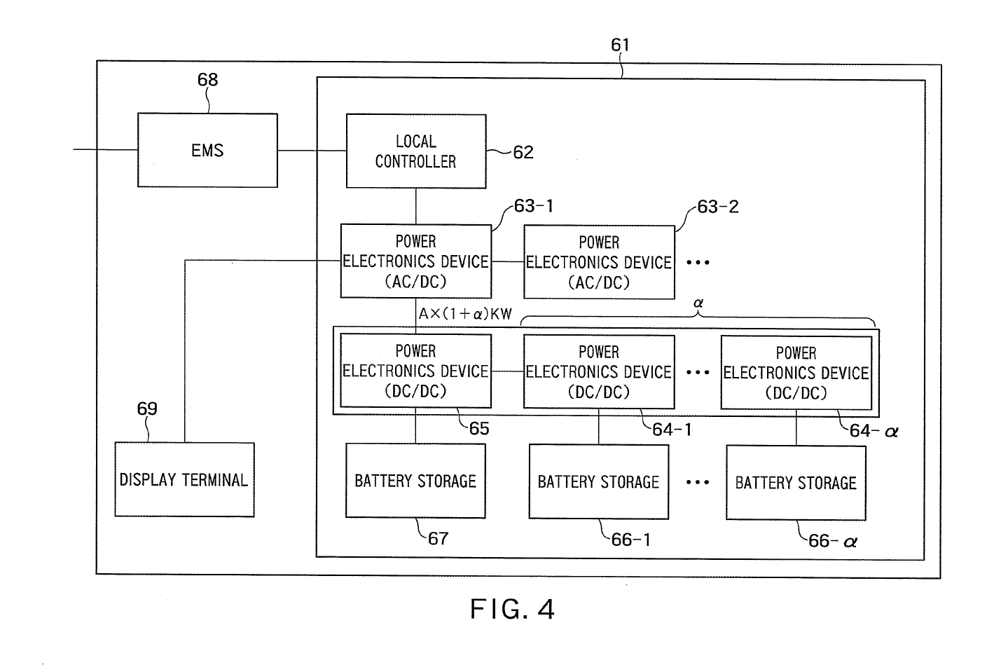

Here, an input/output of power through the power electronics device 43 may be referred to as “discharge and charge.” This means that not only the battery storage (BMU) 42 but also natural energy such as wind power and solar power generation and the power exchanged with the power system network are the targets in the embodiment. In an electrical system formed with aggregation of power electronics devices, although the power electronics devices have a role to switch the input/output direction of power, this is explained in detail in FIG. 4 below.

Although the EV system 51 in FIG. 3 employs a configuration similar to the battery storage system 41 in FIG. 2, they are different in that a power electronics device 54 operating as a battery charger exists in addition to a power electronics device 53 that is connected to the battery storage 52 and operates. The EV system 51 is connected to each EMS 56 through a communication network and power network 55.

The power electronics device 53 connected to the battery storage 52 in the EV system 51 in FIG. 3 relays power and communication information between the battery storage (BMU) 52 and the power electronics device (i.e. battery charger) 54. In this case, the power electronics device 53 does not necessarily have to have a communication capability to communicate with each EMS on the power system network or a customer's premise. That is, in the example of FIG. 3, there is a feature that an alternating-current/direct-current conversion function in the power electronics device 43 in the battery storage system 41 in FIG. 2 is shifted to the battery charger side corresponding to the power electronics device 54. That is, in the configuration in FIG. 3, the power electronics device 53 implements direct-current/alternating-current conversion and the power electronics device 54 implements direct-current/alternating-current conversion. However, a specific procedure to realize the embodiment is common in FIG. 2 and FIG. 3, and, furthermore, the role of the EV system 51 can be defined to the same role as the battery storage system 41. Further, although there are multiple formats that: algorithm processing related to discharge and charge with respect to the battery storage (BMU) is integrated into the power electronics device 53; the algorithm processing is integrated into the power electronics device (i.e. battery charger) 54; and the algorithm processing is integrated into HEMS/BEMS on a customer's premise or EMS in the power system network, the embodiment can be realized in the same framework even if any configuration is used.

FIG. 4 illustrates a system configuration view by multiple power electronics devices according to the embodiment. Such a system configuration can be arranged in any of the power system side and the customer side.

In the case of combining multiple storage batteries (or natural energy systems) and forming aggregation of power units, the aggregation includes one or multiple local controllers, power electronics devices (AC/DC or DC/DC) and storage batteries. In the example in the figure, a local controller 62, power electronics devices (AC/DC or DC/DC) 63-1, 63-2, 65 and 64-1 to 64-α and storage batteries 67 and 66-1 to 66-α are displayed in a power system 61 corresponding to the aggregation. Also, a line connecting element blocks illustrated in FIG. 4 shows a schematic hierarchical configuration between the elements, and does not necessarily correspond to an actual power line connection relationship.

In the case of such aggregation 61, communication between each external EMS 68 and the local controller 62 (the local controller itself can be omitted) corresponds to the examples in FIG. 2 and FIG. 3, and realizes a power application such as control of active power or reactive power and control of allocation of output/input power amount. The EMS 68 and the local controller 62 correspond to examples of a higher-order control device. In the case of performing communication in multiple power electronics devices, it is possible to activate the multiple power electronics devices in parallel and realize a power application such as control of a phase synchronization of output power for an output increase of power. In the example in FIG. 4, when it is assumed that inputs/outputs of the power electronics devices 65 and 64-1 to 64-α are A kW, by activating 1+α items in parallel, a power input/output of A×(1+α) kW can be intended.

An object of the phase synchronization of output power is to prevent an occurrence of cross current (e.g. reactive current caused by a difference of electromotive force, synchronization cross current caused by a phase difference of electromotive force and harmonic cross current caused by a waveform difference of electromotive force) in an output on the alternating-current side. To this end, however, a problem is that correct synchronization is not found unless a control subject to identify a synchronization source device is determined (i.e. master/slave determination) in addition to information communication between power electronics devices operating in parallel.

To be more specific, there is a feature that, for example, in the case of connection to a large power signal such as the power system network, a power electronics device does not especially have to exchange information for synchronization via a communication network and gradually synchronizes with the power network signal by electrical characteristics. However, a problem in a case where the scale of input/output electric energy is substantially constant and multiple items operate at the same time as illustrated in FIG. 4 is that, unless information of a target for synchronization is exchanged via a communication network, a power input/output intended by the user of the power electronics devices is not performed. Also, as illustrated in FIG. 4, by communicatively connecting a power electronics device (i.e. the power electronics device 63-1 in the example in FIG. 4) to a display terminal 69, it is possible to realize a power application for a data monitor, abnormal report or parameter adjustment.

Also, on the power system network side, to respond to an instantaneous load change, each battery storage generally supports a function called “ancillary service.” In this case, since it is necessary to secure a large storage capacity equal to a power plant, as illustrated in FIG. 4, it is desirable to install multiple distributed power sources (i.e. battery storage or natural energy system) connected to power electronics devices. Meanwhile, even on the customer side, it is a common practice to provide a function called “peak shift” to store nighttime power of a lower unit price to implement interchange in a time zone in which the diurnal power use is peak. In addition to this, it can be considered to apply an application in which, under a condition to give a certain incentive to the customer side, an electric power provider uses the storage batteries installed on the customer side or power of natural energy. In these uses, regarding the subject of the control right, since power storage and power interchange simultaneously occur in a case where there are multiple users, a system configuration is assumed in which there are multiple control subjects and uncontrolled subjects together.

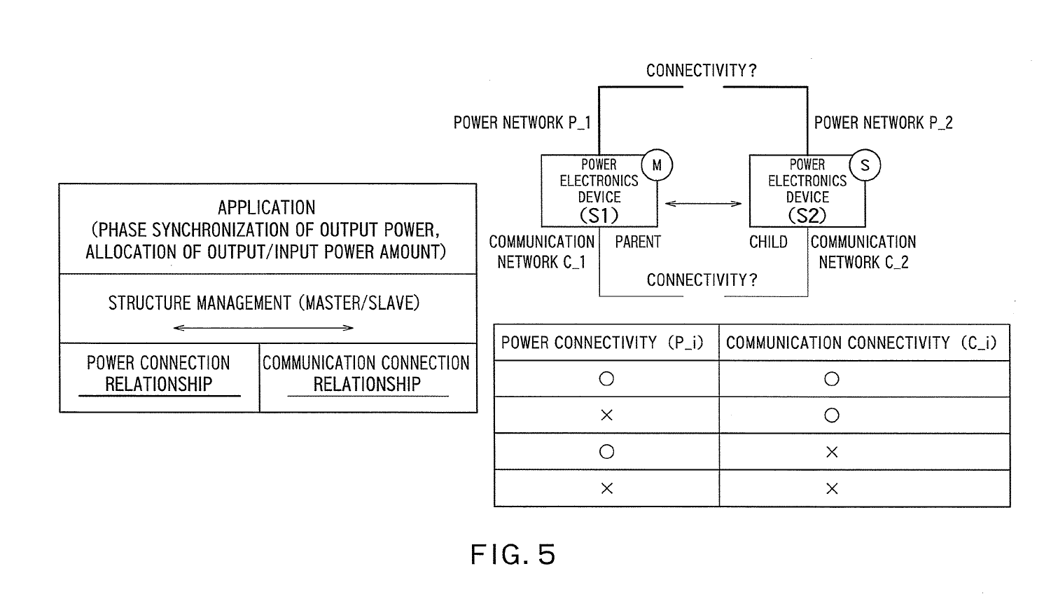

FIG. 5 presents a conceptual view related to a connection relationship between a plurality of power electronics devices according to an embodiment. As illustrated in the example of the figure, the power electronics devices can realize different applications (e.g. phase synchronization of output power and allocation of output/input power amount) depending on the intended purpose, and, furthermore, there may be a case where the communication connection relationship and the power connection relationship do not have a one-to-one correspondence with each other.

For example, a set of power electronics devices is defined as S and subsets of S are defined as S1 and S2 (S1∪S2=S, S1∩S2=0). It is assumed that a power electronics device of Si (i=1, 2) is connected to power network Pi and communication network Ci. As illustrated in FIG. 5, there are totally four kinds of relationships between communication connection and power connection.

That is, there are relationships where: [1] power connection is established (◯) and communication connection is established (◯); [2] power connection is not established (x) and communication connection is established (◯); [3] power connection is established (◯) and communication connection is not established (x); and [4] power connection is not established (x) and communication connection is not established (x).

Depending on each of these four states, it is necessary to decide whether to perform processing to determine a master (parent) and a slave (child), that is, whether to perform master determination processing. For example, even if the communication connection relationship is established, in a case where the power connection relationship is not established, since two power electronics devices are not connected to the same power bus line, it is not necessary to perform synchronization processing for allocation of output/input power amount and phase synchronization of output power. Therefore, a master/slave relationship is not necessary between these two power electronics devices. Furthermore, when there is a master/slave relationship between these two devices, it may be difficult to perform adaptive control in a power system. For example, even if a master power electronics device receives an output instruction of predetermined power from a higher device and gives a allocation of output/input power amount instruction (e.g. an instruction to transmit half power of the predetermined power to the master) to a slave power electronics device, since the slave power electronics device is not actually connected to the same power bus line as that of the master, it is not possible to output the requested power to the master. Therefore, the master cannot receive the requested power from the slave to which the instruction was given, and cannot adequately execute an instruction from the higher device.

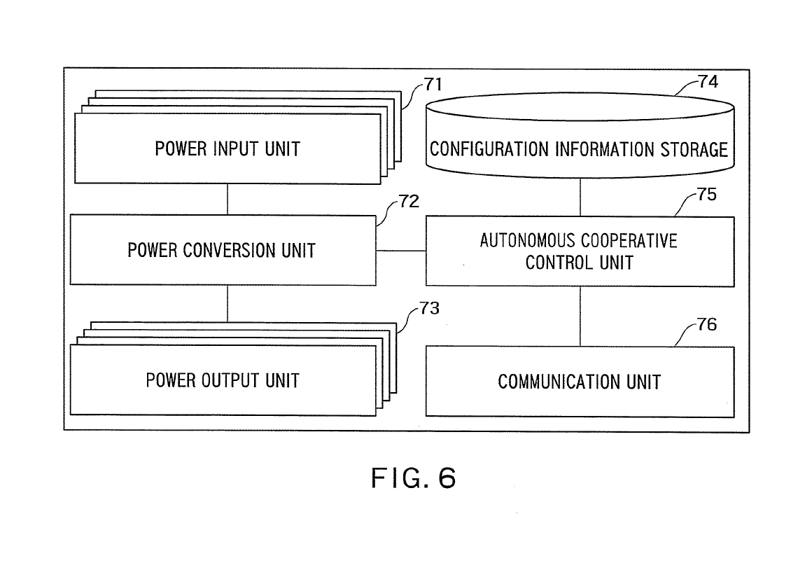

FIG. 6 presents a configuration example of a power electronics device according to the embodiment. As described above, the power electronics device corresponds to the power electronics device in the power system in FIG. 4. Alternatively, it corresponds to the power electronics device connected to the battery storage (BMU) in the power battery system in FIG. 2. Alternatively, it corresponds to the power electronics device 53 connected to the battery storage (BMU) in the EV system in FIG. 3 or the power electronics device 54 connected to the battery charger. Further, the embodiment is similarly applicable to the case of connection to a natural energy system such as solar power generation and wind power generation.

In the embodiment, by causing multiple converters having a communication function to act in an autonomous cooperative manner and determine a master/slave relationship, it is possible to maintain the flexibility of installation locations while automatically increasing the capacity and maintaining the total charge/discharge power throughput amount of distributed power sources at the time of expansion and maintenance. It is needless to say that part or all of components in FIG. 6 are not limited to be applied to a power electronics device but are similarly applicable to an EMS or a local controller and can be implemented.

The power electronics device in FIG. 6 is formed with power input units (i.e. power connection units) 71, a power conversion unit 72, power output units (i.e. power connection units) 73, a configuration information storage 74, an autonomous cooperative control unit 75 and a communication unit 76. The power input units 71 and the power output units 73 are connected to power lines and connected to other devices (e.g. discharge device such as a power electronics device, controller, EMS, battery storage and natural energy system) via the power lines.

Specifically, the power input units 71, the power conversion unit 72 and the power output units 73 play roles of direct-current/alternating-current, direct-current/direct-current or alternating-current/alternating-current power conversion, frequency monitoring and adjustment of power and change detection and adjustment of voltage. In the example in the figure, although there are multiple power input units 71 and power output units 73, the number of each of them may be one in actual implementation.

In actual implementation, in a case where a power electronics device is connected to a battery storage (BMU), there are two methods that: power from the battery storage (BMU) is input in the power input units 71 via the power lines; and power input from the power lines are output from the power output units 73 to the battery storage (BMU) side via the power lines. Regarding the power input units or the power output units, in addition to a method of preparing each of them as a physical circuit, a method of commonly preparing them in the same circuit is possible. By this means, the power electronics device implements charge/discharge control with respect to the natural energy system or the battery storage (BMU).

Even when any of the electric energy expressed in Wh (Watt hour), the electric energy expressed in Ah (Ampere hour) and the electric energy expressed in Vh (Volt hour) is used as the electric energy at the time of charge/discharge control, the embodiment can be similarly implemented.

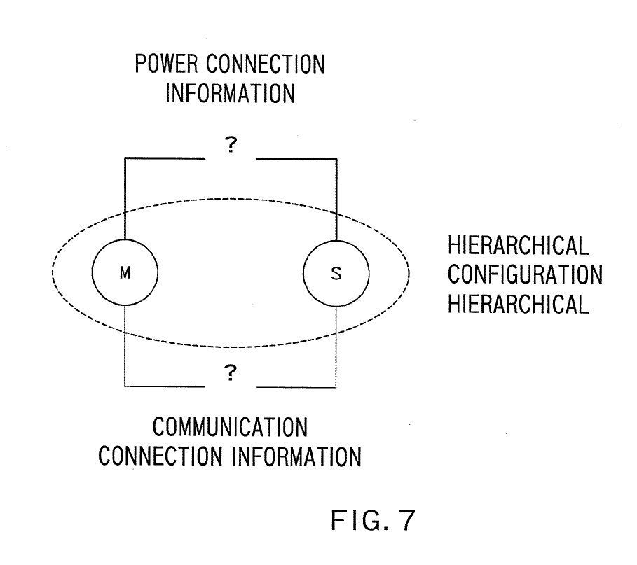

In the embodiment, the configuration information storage 74 stores three kinds of information of hierarchical configuration information, power conversion characteristic information and operation plan information as shown in FIG. 7. Other information than these three kinds of information can be used as information stored in the storage 74.

In view of the power electronics device, the hierarchical configuration information indicates information of a master (parent) device and slave device. In the example of FIG. 7, it is illustrated such that a power electronics device on the left side is the master (M) and a power electronics device on the right side is the slave (S).

The communication connection information denotes information indicative of whether it is possible to perform direct communication between two devices. To be more specific, the communication connection information indicates a wire connection state in the case of wire communication and a radio propagation range state in the case of wireless communication. By extension, the communication connection information can include a case where communication connection is possible through any of the devices.

The power connection information denotes information as to whether power lines are in a wire connection state between two devices, that is, whether the same bus line is shared. Regarding this, a plurality of items may be managed every format of power exchanged between devices, such as wire connection by direct current and wire connection by alternate current. For example, regarding specific device types to determine a master and a slave, there is information as to alternate current/alternate current (AC/AC), alternate current/direct current (AC/DC) and direct current/direct current (DC/DC).

Here, the power electronics device may have a unique physical device configuration per power conversion function or functions may be commonalized. For example, in the case of commonalizing the functions, the power electronics device can perform not only alternating-current/direct-current (AC/DC) conversion but also direct-current/direct-current (DC/DC) conversion. At this time, regarding expression of the power conversion characteristic information, there are a method of describing all possible power conversion functions and a method of performing description in association with a role determined at the time of actually connecting to a power line and inputting/outputting power. In the case of connection to at least one bus line (or device on the bus line) for alternating current and connection to at least one bus line (or device on the bus line) for direct current, power conversion characteristic information of the power electronics device describes alternating-current/direct-current (AC/DC), for example. In the case of only one type of them, it describes alternating-current/alternating-current (AC/AC) or direct-current/direct-current (DC/DC), for example.

The autonomous cooperative control unit 75 in FIG. 6 detects a configuration change related to other devices (e.g. attachment/detachment of a device and addition/removal/stop/restart of a device function), updates the hierarchical configuration information, the power conversion characteristic information and the operation plan information in the configuration information storage 74 and manages an input and output of power. Details are described below.

The communication unit 76 in FIG. 6 plays a role of generating information such as hierarchical configuration information, communication connection information and power connection information as communication messages and transmitting/receiving them through an EMS, local controller, other power electronics devices or communication network. In addition to a case where the communication unit 76 performs processing of transmitting/receiving a communication message, there is a case where it has a first communication unit and a second communication unit as communication media.

For example, the first communication unit is realized by a wireless communication medium such as IEEE802.11, Bluetooth and ZigBee, in addition to a wire communication medium such as an optical fiber, telephone line and Ethernet. A communication medium in the present embodiment does not depend on a specific communication medium. The power electronics device acquires communication messages from the EMS, the local controller and other power electronics devices through the first communication unit.

Meanwhile, the second communication unit acquires characteristic information (such as rated capacity, charge/discharge start/end voltage, upper limit temperature, lower limit temperature, maximum charge/discharge current and rated voltage) which is unique information of the battery storage (BMU) or natural energy system connected to the power electronics device, and further acquires measurement information or setting information during operation. In a case where the battery storage (BMU) is connected to the power electronics device, measurement information (such as SOC, SOH, charge/discharge current and charge/discharge voltage) which is variation information at the time of an operation of the battery storage (BMU) is periodically acquired. The second communication unit can be realized by CAN which is a general interface standard of the battery storage (BMU), a wired/wireless communication medium such as Ethernet or an electrical signal line uniquely assumed by a vendor who handles manufacture of a battery storage system, while the embodiment does not depend on a specific medium.

Also, in a case where the battery storage is connected to the power electronics device, since an internal battery cell generally has a feature of self-discharge, at the time of transmitting information such as SOC and SOH to the EMS, the local controller or other power electronics devices, it is not necessarily completed by only one transmission. Similar to information of voltage or current, it is desirable to timely report it taking into account a feature that the value changes over time. The power electronics device is not limited to be connected to the battery storage (BMU), can be connected to solar power generation and wind power generation or various EMS's and local controller that communicate with them.

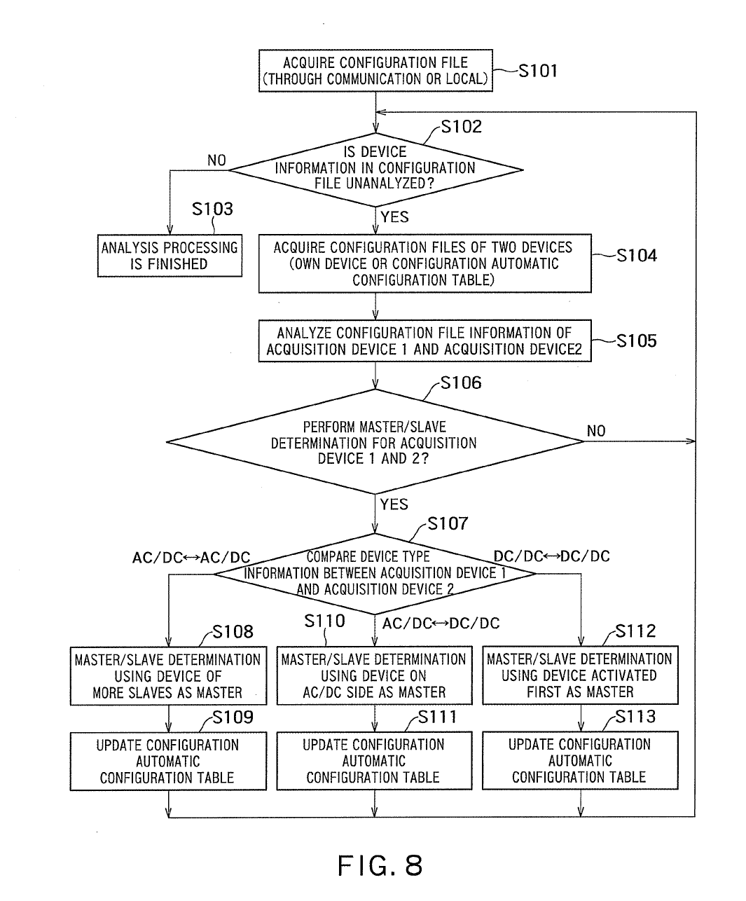

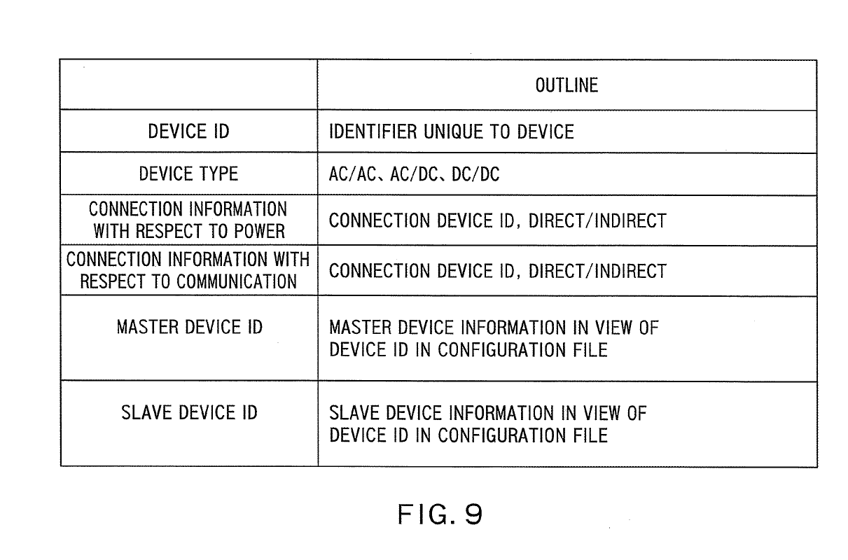

FIG. 8 presents an entire operation flowchart related to the embodiment and the second embodiment described below. Also, FIG. 9 presents content of a configuration file treated during an operation of the flowchart in FIG. 8.

The configuration file is formed every device (e.g. power electronics device, EMS or local controller) and includes information such as the device ID, the device type, connection information with respect to power (power connection information), connection information with respect to communication (communication connection information), the master device ID and the slave device ID. These items of information are part of information stored in the configuration information storage 74 in the power electronics device illustrated in FIG. 6.

The device type in FIG. 9 corresponds to the power conversion characteristic information and the master device ID and the slave device ID in FIG. 9 correspond to the hierarchical configuration information in FIG. 7. The device ID denotes personal information unique to the device, which is uniquely identifiable information such as the serial number and the MAC address of a communication adaptor.

The device type corresponds to the power conversion characteristic information and indicates information such as alternating-current/alternating-current (AC/AC), alternating-current/direct-current (AC/DC) and direct-current/direct-current (DC/DC). The device type can be used to determine a master or slave.

The master device ID or the slave device ID denotes information of a master device or slave device in view of the device ID in the configuration file. In the example in FIG. 7, regarding the power electronics device in the left side, the master device ID is described as the own ID (or, which can be omitted) and the slave device ID is described as the ID of the power electronics device in the right side.

The connection information with respect to power indicates information of a device that is connected to the same power line as the above device and supplies power in a direct or indirect manner.

The connection information with respect to communication indicates information of a device that is connected to the same communication medium (including wireless) as the above device and can exchange (or relay) information in a direct or indirect manner.

The power electronics devices, various EMS's or local controllers according to the embodiment exchange communication messages including part or all of the configuration file information in FIG. 9 and determine a master or slave in the hierarchical configuration. The operation flowchart in FIG. 8 indicates operations inside the power electronics device at the time of acquiring these items of configuration file information.

First, configuration file information is acquired from a communication network or a local storage area (S101). Next, it is checked whether the acquired configuration file information has been analyzed (S102). This step can be omitted. However, in a case where a system formed with multiple power electronics devices is huge, for example, it is preferable that from the standpoint of reducing processing load or giving priority to the latest configuration information, information having been analyzed in the past is not targeted for subsequent processing (S103).

Subsequently, in order to perform comparison with the configuration information of device (referred to as “acquisition device 1”) in the first step and determine a mutual relationship of master and slave, the power electronics device acquires information of itself or a different device (referred to as “acquisition device 2”) stored in a configuration automatic configuration table by the device (S104).

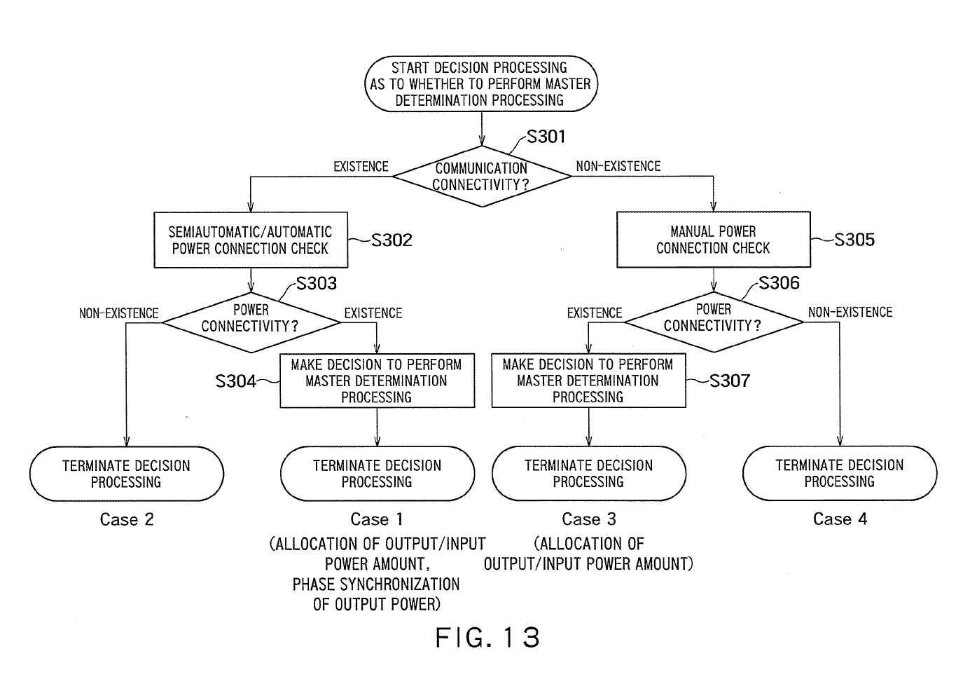

Subsequently, power connection information and communication connection information between the two devices are checked (S105), and it is decided whether to perform master determination processing (S106). For example, in a case where there is at least the power connection relationship, the flow proceeds to step S107, and, in a case where there is no power connection relationship, the flow returns to step S102. This decision processing in step S106 is main processing in an embodiment, and FIG. 13 presents a more detailed operation flowchart of the procedure. FIG. 13 is described later in detail.

Subsequent steps denote a basic decision algorithm to determine a master and a slave between devices (e.g. power electronics device, EMS and local controller) according to the embodiment described below.

In step S107, the device type information of the acquisition device 1 and the device type information of the acquisition device 2 are compared to determine a master device and slave device by three rough patterns. To be more specific, the master device and the slave device are determined based on whether one device is alternating-current/direct-current (AC/DC) and the other device is direct-current/direct-current (DC/DC), whether both devices are alternating-current/direct-current (AC/DC) and whether both devices are direct-current/direct-current (DC/DC).

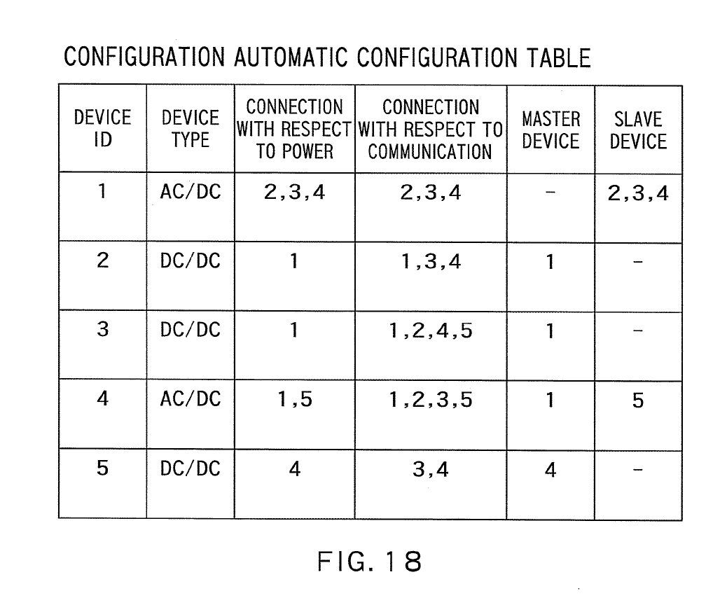

For example, in a case where one device is alternating-current/direct-current (AC/DC) and the other device is direct-current/direct-current (DC/DC), this corresponds to, in the example shown in FIG. 4, information comparison between the power electronics device (AC/DC) connected to a power network on the system side and the power electronics device (DC/DC) connected to a battery storage or natural energy. As illustrated in the example in FIG. 4, basically, the power electronics device (AC/DC) connected to the power system side accepts control such as active power or reactive power in cooperation with an upper EMS or local controller, and implements a control instruction such as allocation of output/input power amount to the other power electronics device (e.g. DC/DC). Therefore, to determine a master and slave with respect to power, it is preferable to preferentially select a power electronics device on the alternating-current/direct-current (AC/DC) side as a master (S110). After a master/slave relationship is determined, information on the configuration automatic configuration table (see FIG. 18) is updated (S111). Details of this configuration automatic configuration table are described below again.

Meanwhile, for example, in a case where both devices are alternating-current/direct-current (AC/DC), this corresponds to information comparison between multiple power electronics devices (AC/DC) connected to the power network on the system side, in the configuration example in FIG. 4. Since this case relates to an operation at the time when the multiple power electronics devices operate in parallel and expansion of the power capacity is intended, one device of the multiple devices is selected as a device having a role of master, and, based on a reference value of the device, synchronization control is implemented for the other power electronics devices. As a selection criterion of the master device in this case, it is preferable to use information such as connectivity with the upper EMS or local controller; magnitude of the total power value as a whole, including a slave power electronics device(s) thereof (i.e., electric energy which can be handled under each power electronics device); and the number of slave power electronics devices. In addition to the above information, it is possible to use information related to maintenance of a device operation state or version. In the example in FIG. 8, as an example, a state is described where a power electronics device having a larger number of managed slaves is preferentially selected as a master device (S108). After the master/slave determination, the configuration automatic configuration table (FIG. 18) is updated (S109).

Finally, for example, in a case where both devices are direct-current/direct-current (DC/DC), this corresponds to information comparison between multiple power electronics devices (DC/DC) connected to the battery storage or natural energy in the configuration example in FIG. 4. A configuration is specifically assumed where multiple power electronics devices are connected to a common DC bus. In this case, since each power electronics device (DC/DC) inputs/outputs power on the terminal direct current line without being connected to an upper power system network, there are some decision criteria such as random selection and preferential selection of a power electronics device (DC/DC) activated first. In addition to these criteria, it is possible to use information related to maintenance such as a device operation state or version. In the example of FIG. 8, it presents a state where the device activated first is preferentially selected as a master device (S112). Similar to other examples, after that, the configuration automatic configuration table is updated (S113).

Here in addition to these three kinds of decision examples, there is a case where both devices to be compared are alternating-current/alternating-current (AC/AC). Although it is omitted in the example of the figure, it is possible to similarly apply other methods described herein, such as connectivity with an upper EMS or local controller, random selection, preferential selection of a device activated first, the total amount value of slave devices or the number.

The above-described master determination processing is naturally targeted for a power electronics device connected to the same power line as the own power electronics device and can be targeted for a different power electronics devices connected to another power line. In a case where the different power electronics device does not have a function of master determination processing, the master determination processing may be performed in response to a request from the different power electronics device. In this case, a result of master processing (i.e. master/slave type) may be reported to the different power electronics devices.

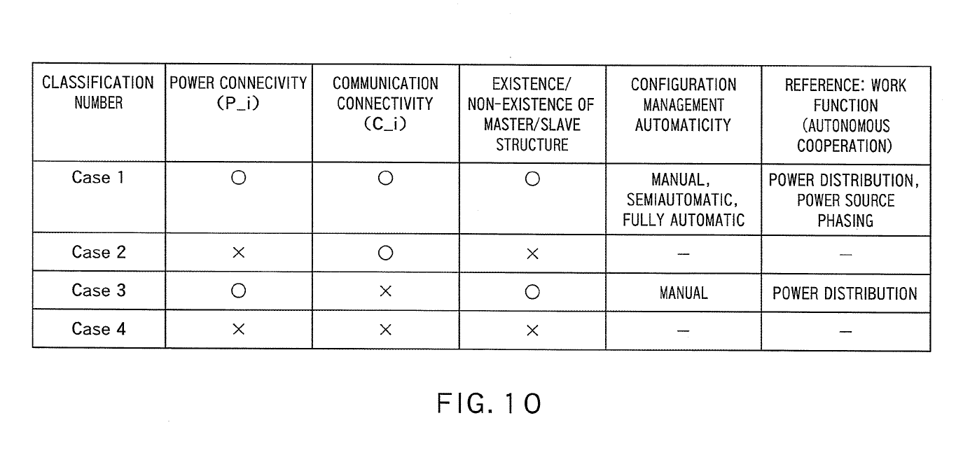

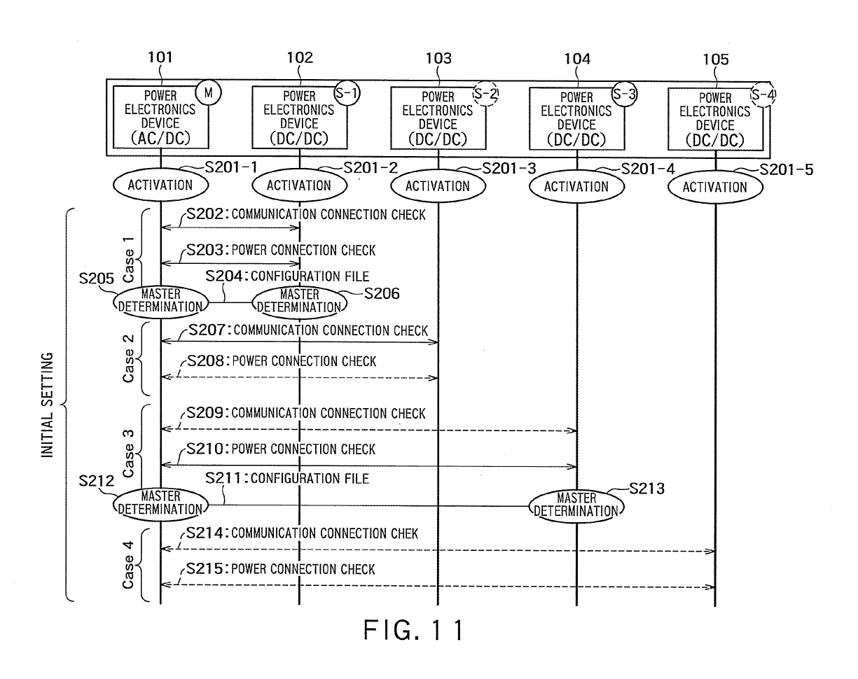

FIG. 10 illustrates classification to decide whether to perform master determination processing according to an embodiment. FIG. 11 illustrates an operation sequence every classification.

As illustrated in FIG. 10, there are totally four kinds of combinations between power connection relationship (P_i) and communication connection relationship (C_i). This has already been explained using FIG. 5.

Case 1 denotes a case where there are the power connection state and the communication connection state. In this case, it is possible to realize power applications such as allocation of output/input power amount and phase synchronization of output power between two power electronics devices.

The “configuration automatic configuration automaticity” illustrated in FIG. 10 indicates a rough standard with respect to realization without user (or operator) operations at the time of checking the power and communication connection relationships. The “manual” denotes a format in which the user individually performs visual contact or uses design drawings to check individual connection relationships and input the connection relationships in a power electronics device. The “fully automatic” denotes a format in which, in the case of not only communication but also power, a pulse such as voltage is applied from one side of a power bus line and detected from the other side to decide a power connection relationship. The “semiautomatic” is the medium between the “manual” and the “fully automatic,” and denotes a format in which both two power electronics devices perform a connection check by a certain input from the user and detect a shift to a connection state to decide communication and power connection relationships. Regarding the fully automatic and semiautomatic processing, it is possible to cause an autonomous cooperation control unit 75 included in a power electronics device to perform control with respect to the processing.

Case 2 denotes a case where the power connection state is not established and the communication connection relationship is established. Case 4 denotes a case where none of the power connection state and the communication connection state is established. If a bus line is different between power devices, since synchronization processing is not necessary between the power devices, it is not necessary to determine a master and a slave. As described above, when the master/slave relationship is established, it is not possible to correctly process an instruction from a higher order, and it may be difficult to perform adaptive control in a power system. Therefore, it is preferable to prohibit execution of master determination processing between power electronics devices corresponding to Case 2 and Case 4.

Case 3 denotes a case where the power connection relationship is established and the communication connection is not established. In this case, except for a power application of phase synchronization of output power, operations according to autonomous cooperation can be performed, and therefore a master power electronics device is manually determined. Regarding the phase synchronization of output power, since it is necessary to exchange information in real time for synchronization even when a plurality of power electronics devices are operating, the communication connection relationship is essential, but, in the case of allocation of output/input power amount, a format is possible in which they are set in a fixed manner and operated even if the communication connection relationship is not established.

At the initial setting time of power electronics devices, the power electronics devices decide four states from Case 1 to Case 4. In the case of Case 1 or Case 3, master determination processing is performed to establish a master/slave relationship, and, in the case of Case 2 or Case 4, the master determination processing is not performed (i.e. the master/slave relationship is not established). At the time of configuration change detection, master redetermination is not necessary in a change between Case 1 and Case 3 or between Case 2 and Case 4, and the master redetermination is decided in other cases. This is described later in detail.

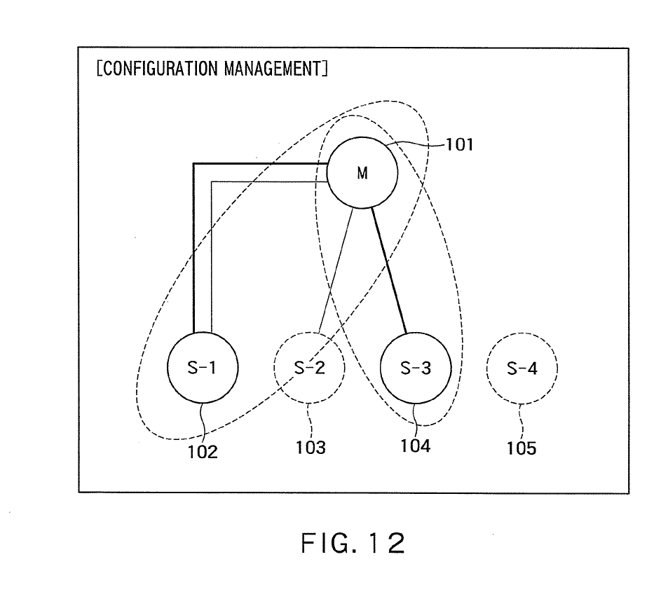

The operation sequence illustrated in FIG. 11 illustrates a case where one power electronics device (AC/DC) and four power electronics devices (DC/DC) are installed. In the example in the figure, it is assumed that the power connection relationships and communication connection relationships between the power electronics devices are as illustrated in the state in FIG. 12.

In FIG. 12, a bold line indicates a power connection relationship and a thin line indicates a communication connection relationship. Power electronics devices 101 and 102 are connected in both power and communication. Power electronics devices 101 and 103 are not connected in power but are connected in communication. Power electronics devices 101 and 104 are connected in power but are not connected in communication. Power electronics devices 101 and 105 are not connected in both power and communication.

As the first step, it is assumed that five power electronics devices 101 to 105 complete activation processing (S201-1, S201-2, S201-3, S201-4 and S201-5). At this time, communication and power connection relationships are checked (S202, S203, S207, S208, S209, S210, S214 and S215). It is decided that the power electronics devices 101 and 102 have communication connection and power connection, which corresponds to Case 1. It is decided that the power electronics devices 101 and 103 have communication connection but do not have power connection, which corresponds to Case 2. It is decided that the power electronics devices 101 and 104 do not have communication connection but have power connection, which corresponds to Case 3. Since the power electronics devices 101 and 105 do not have communication connection and power connection either, they do not detect each other as long as information is input from the outside. The classification between the power electronics devices 101 and 105 corresponds to Case 4.

After that, a device found to have at least power connection with a different device generates a communication message including configuration file information and implements report processing on the different device having at least the power connection (S204 and S211). As the report processing, it may be possible to use push-type unicast communication with respect to individual devices or pull-type unicast communication in addition to a method of concurrent distribution using multicast/broadcast communication, but it does not depend on a specific format. Here, although a case has been illustrated where only a device found to have power connection with a different device reports configuration file information to the different device, a device found to have only communication connection with a different device may report configuration file information to the different device. Also, the report destination may include other devices than the different device having a power or communication connection relationship, by using the above multicast/broadcast communication. Regarding a device for which it is found to have no communication and power connection relationships, the manager (i.e., user) may register configuration file information of the device.

As the second step, in Case 1 and Case 3, a master/slave determination algorithm is performed on each device (S205, S206, S212 and S213). That is, master determination processing is performed on each device. Under a decision criterion that one alternate current/direct current (AC/DC) device is preferentially determined as a master, the device 101 is determined as the master and two direct current/direct current (DC/DC) devices 102 and 104 having a power connection relationship with the device are determined as slaves.

After that, the power electronics device (AC/DC) 101 determined as the master generates and transmits a communication message to report the determination to other devices. This report is omitted in FIG. 11. The report destination of the report message is not limited to the devices determined as the slaves but may include other devices with which communication is possible. In a case where there is no communication connection with a device determined as a slave, the manager (i.e., user) may register master/slave ID information of the slave device. A role of the message can be realized even in the case of the same content as a communication message related to the above configuration file. Also, the master/slave determination according to an embodiment is not limitedly applicable to a power electronics device but is applicable to an arbitrary device as long as the device includes a power conversion function. For example, it is adequately applicable to a higher control device such as an EMS and a local controller.

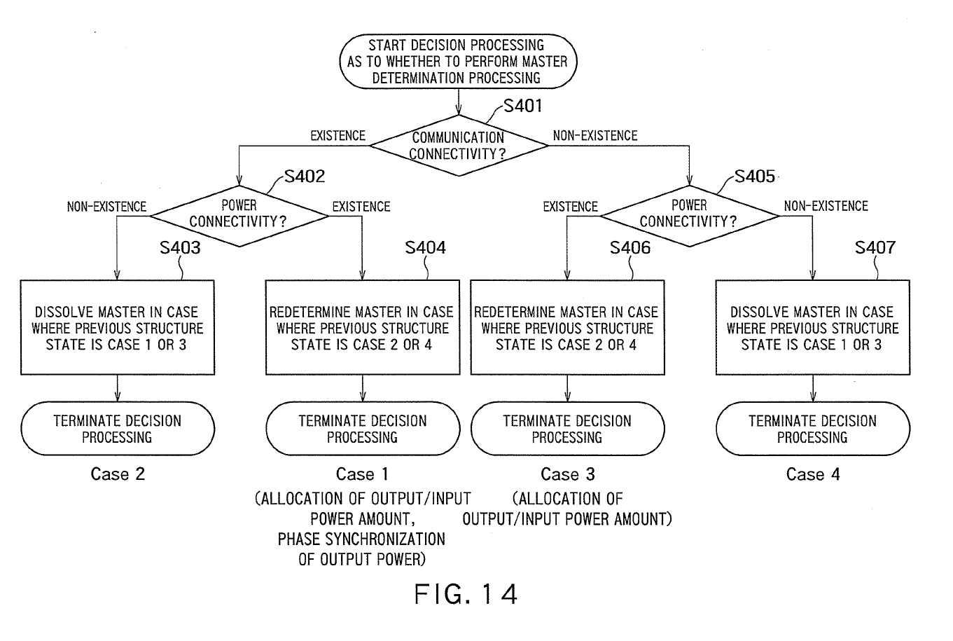

FIG. 13 and FIG. 14 are flowcharts to decide whether to perform master determination processing according to an embodiment. FIG. 13 illustrates a decision flowchart at the initial setting time and FIG. 14 illustrates a decision flowchart at the time of configuration change detection. These decisions are basically to decide four kinds of connection relationship combination states (i.e. Case 1 to Case 4) presented in FIG. 10.

In the flow at the initial setting time in FIG. 13, whether there is communication connectivity is checked (S301), and, if there is the communication connectivity, a power connection check test is conducted in a semiautomatic/automatic (see FIG. 10) manner (S302). Whether there is power connectivity is checked (S303), and, if there is no power connectivity (which corresponds to Case 2), it is determined not to perform master determination processing. If there is the power connectivity (which corresponds to Case 1), it is determined to perform the master determination processing (S304). Meanwhile, if there is no communication connectivity, the power connection check test is manually conducted (S305). Whether there is power connectivity is checked (S306), and, if there is no power connectivity (which corresponds to Case 4), it is determined not to perform master determination processing. If there is the power connectivity (which corresponds to Case 3), it is determined to perform the master determination processing (S307).

In the flow at the configuration change detection time in FIG. 14, in a case where at least one of communication and power connection relationships is changed, decision processing as to whether to perform master determination processing (i.e. master redetermination processing) is implemented. When a power connection state between two devices is changed, there are two kinds of cases where the master redetermination processing is necessary and where the master redetermination processing is unnecessary.

At the time of the configuration change detection, first, whether there is communication connectivity is checked (S401), and, if there is the communication connectivity, next, whether there is power connectivity is checked (S402). If there is no power connectivity (which corresponds to Case 2), a master/slave relationship is dissolved in a case where the previous configuration state is Case 1 or Case 3, and processing related to the master/slave relationship is not performed in a case where the previous state is Case 4.

If there is the power connectivity in step S402 (which corresponds to Case 1), in a case where the previous configuration state is Case 2 or Case 4, it is determined to perform master/slave redetermination processing (S404). Here, in a case where the previous configuration state is Case 3, when it shifts to Case 1, it may be possible to perform not only allocation of output/input power amount but also phase synchronization of output power control.

Meanwhile, if there is no communication connectivity in step S401, whether there is power connectivity is checked (S405). If there is no power connectivity (which corresponds to Case 4), a master/slave relationship is dissolved in a case where the previous configuration state is Case 1 or Case 3 (S407), and processing related to the master/slave relationship is not performed in a case where the previous configuration state is Case 2. If there is the power connectivity (which corresponds to Case 3), in a case where the previous configuration state is Case 2 or Case 4, it is determined to perform master/slave redetermination processing (S406). Here, in a case where the previous state is Case 1 and phase synchronization of output power control is performed, when it shifts to Case 3, it follows that execution of the phase synchronization of output power control is stopped.

Here, in a case where wireless communication is used for communication between power electronics devices, wireless communication connection may be temporarily disconnected depending on an environmental characteristic of a propagation channel. In such a case, depending on the connection state, it may be possible to perform an operation of stopping a phase synchronization function of output power and working only a allocation of output/input power amount function, or perform an operation of deferring a decision for master redetermination in order to prevent overhead due to repeated configuration changes.

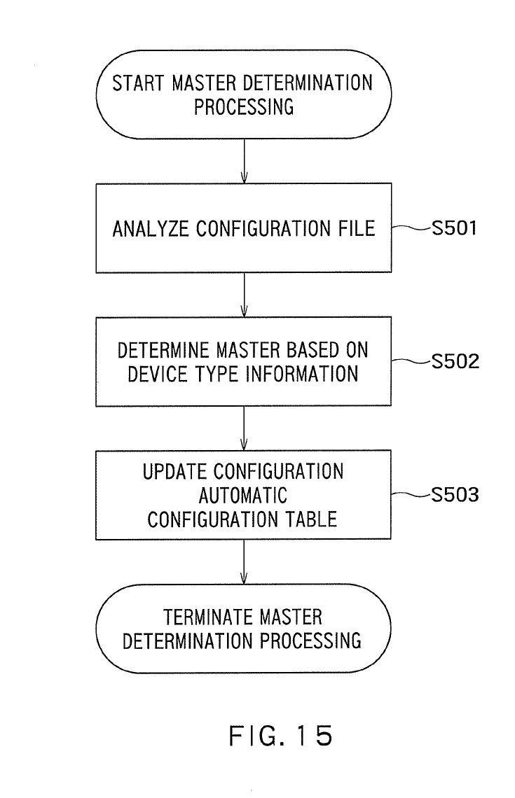

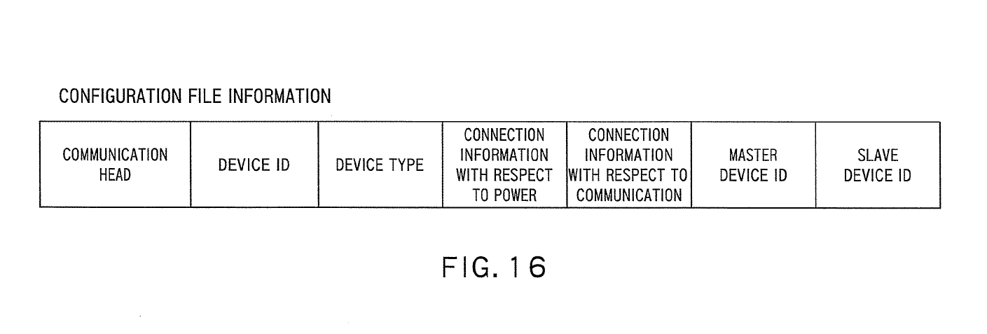

Also, after it is determined to perform the master determination processing in the flow in FIG. 13 or the master redetermination processing in the flow in FIG. 14, master determination processing is implemented in an operation flowchart as illustrated in FIG. 15. This corresponds to a partially extracted part of the flow in FIG. 8. To be more specific, a configuration file is analyzed (S501), a master is determined based on device type information (S502) and a configuration automatic configuration table to be described later is updated (S503). A format of a communication message including configuration file information further includes a communication header, which is as illustrated in FIG. 16.

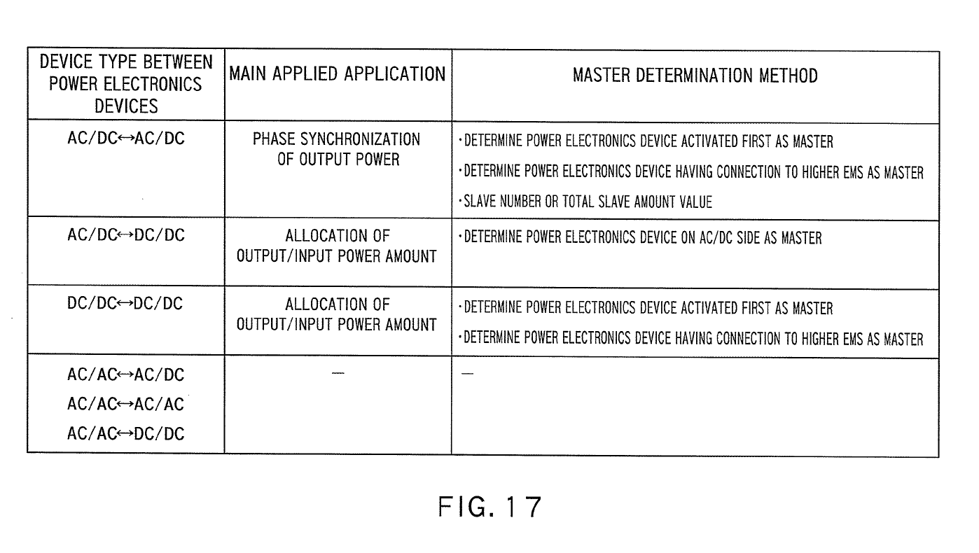

Although the configuration file information includes device type information of power electronics devices, a master and a slave are determined between two devices according to the preference criteria illustrated in FIG. 17. In connection between a power electronics device (AC/DC) and a power electronics device (AC/DC), since a phase synchronization of output power application is implemented, the total amount value or number of slaves and the connectivity with a higher order are considered. In the case of a power electronics device (AC/DC) and a power electronics device (DC/DC), since a allocation of output/input power amount application is implemented such that an instruction value from a higher order is distributed between devices, the power electronics device (AC/DC) connected to alternate current is preferentially determined as a master. Meanwhile, in the case of a power electronics device (DC/DC) and a power electronics device (DC/DC), there is a method of preferentially determining, as a master, a power electronics device which has connectivity with a higher order or is activated first. After the determination, the configuration automatic configuration table is updated.

FIG. 18 illustrates an example of the configuration automatic configuration table. Such a configuration automatic configuration table is shared between devices to store information related to a master/slave relationship and power/communication connectivity with respect to each device. Using a device ID as a key, the table individually describes information of: a device type; a device having a power connection relationship; a device having a communication connection relationship; a master device with respect to the device; and a slave device with respect to the device. For example, in a power electronics device M-2 (AC/DC) with a device ID of 4, it is found that the device type is alternate current/direct current (AC/DC), power electronics devices with device ID's of 1 and 5 have the power connection, power electronics devices with device ID's of 1, 2, 3 and 5 have the communication connection, a power electronics device with a device ID of 1 is a master device of the device and a power electronics device with a device ID of 5 is a slave device of the device. By communication between devices and by registration of information in a device by the manager (i.e., user), it is possible to share such a management table. Also, it is possible to store only information of devices satisfying conditions defined in advance, without storing information of all devices.

Thus, according to an embodiment, by identifying power electronics devices subject to master/slave determination and making a master/slave determination on the identified power electronics devices, it is possible to maintain the flexibility of installation sites in a case where a plurality of power electronics devices perform autonomous cooperation control, while automatically increasing the capacity and maintaining the total charge/discharge power throughput amount of distributed power sources at the time of expansion and maintenance.

The power electronics devices which have been heretofore described may also be realized using a general-purpose computer device as basic hardware. That is, the power electronics devices can be realized by causing a processor mounted in the above described computer device to execute a program. In this case, the power electronics device may be realized by installing the above described program in the computer device beforehand or may be realized by storing the program in a storage medium such as a CD-ROM or distributing the above described program over a network and installing this program in the computer device as appropriate. Furthermore, the storage in the power electronics device may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power electronics device comprising:
a first connection unit connected to a first power line that is one of a plurality of power lines;
a second connection unit connected to a second power line that is another one of the plurality of power lines;
a power conversion unit configured to convert power input from one of the first connection unit and the second connection unit, and output the converted power to the other of the first connection unit and the second connection unit; and
a control unit configured to identify, based on power connection information indicative of a connection relationship between a plurality of power electronics devices through the plurality of power lines, pick up a group of power electronics devices on the same power line, decide the master power electronics device from the group, and order the master power electronics device to control other power electronics devices among the group with respect to at least one of power output to or power input from the power line.

2. The power electronics device according to claim 1, wherein
the control unit identifies power electronics devices connected to a same power line as the group of power electronics devices, based on the power connection information, and
the master power electronics device determined by the control unit performs control relating to at least one of power output to or power input from the same power line.

3. The power electronics device according to claim 2, wherein
the same power line is one of the first power line and the second power line, and
the power electronics devices connected to the same power line includes the own power electronics device.

4. The power electronics device according to claim 2, wherein the control unit identifies the group of power electronics devices, further using communication connection information indicative of power electronics devices to which communication is available with each other.

5. The power electronics device according to claim 4, wherein the control unit does not pick up a power electronics device that is not connected to the same power line, as a member of the group, s even if the power electronics device can communicate with any other power electronics device connected to the same power line.

6. The power electronics device according to claim 4, wherein the control unit picks up a power electronics device connected to the same power line, as a member of the group, even if the power electronics device cannot communicate with any other power electronics device connected to the same power line.

7. A power electronics method comprising:
reading out power connection information from a storage device, the power connection information being indicative of a connection relationship between a plurality of power electronics devices, the power electronics devices being interconnected through a plurality of power lines, the power electronics devices each converting power input from one power line and outputting the converted power to another power line;
identifying, based on power connection information indicative of a connection relationship between a plurality of power electronics devices through the plurality of power lines, picking up a group of power electronics devices on the same power line, deciding the master power electronics device from the group, and ordering the master power electronics device to control other power electronics devices among the group with respect to at least one of power output to or power input from the power line.

8. A non-transitory computer readable medium including instructions stored therein which cause, when executed by a processor, the computer to execute steps comprising:
reading out power connection information from a storage device, the power connection information being indicative of a connection relationship between a plurality of power electronics devices, the power electronics devices being interconnected through a plurality of power lines, the power electronics devices each converting power input from one power line and outputting the converted power to another power line;
identifying, based on power connection information indicative of a connection relationship between a plurality of power electronics devices through the plurality of power lines, picking up a group of power electronics devices on the same power line, deciding the master power electronics device from the group, and ordering the master power electronics device to control other power electronics devices among the group with respect to at least one of power output to or power input from the power line.

9. A cooperation control system comprising:
a higher control device;
a plurality of power electronics devices including at least one power electronics device according to claim 1;
at least one power device capable of discharging power; and
a plurality of power lines configured to interconnect the plurality of power electronics devices and the power device, wherein
one of the power electronics devices receives a control instruction of power discharge, from the higher control device, and
the power electronics devices perform a coordinated operation based on the control instruction.
